(19) United States
(12) Patent Application Publication
(10) Pub. No.: US 2010/0085918 A1
(43) Pub. Date: Apr. 8, 2010

(54) Method and Apparatus Pertaining to Updating a High-Bandwidth Hardware-Based Packet-Processing Platform Local Session Context State Database

(75) Inventors: Jagadeesh Dantuluri, Aurora, IL (US); Tengywe E. Hong, Naperville, IL (US)

Correspondence Address: FITCH EVEN TABIN & FLANNERY, 120 SOUTH LASALLE STREET, SUITE 1600, CHICAGO, IL, 60603-3406, US

(73) Assignee: VELOCENT SYSTEMS INCORPORATED, Naperville, IL (US)

(21) Appl. No.: 12/574,916

(22) Filed: Oct. 7, 2009

Related U.S. Application Data
(60) Provisional application No. 61/103,457, filed on Oct. 7, 2008.

(51) Int. Cl. H04W 40/00

(52) U.S. Cl. 370/328

(57) ABSTRACT

These various embodiments comprise or are suitable for implementation by a high-bandwidth hardware-based packet-processing platform that is configured to be installed at a traffic-aggregation point for a communications network having a plurality of attachment points at its edge. These teachings provide for receiving (via, for example, a packet-receiving interface) at least substantially all data packets as pass through the traffic-aggregation point and then extracting session context state data from at least a majority of these data packets. By one approach, this session context state data comprises, at least in part, information pertaining to a location as pertains to a calling party (such as the point of network attachment for that calling party). This session context state data is then used to update a local session context state database.

### RELATED APPLICATION(S)

This application claims the benefit of U.S. Provisional application No. 61/103,457, filed Oct. 7, 2008, which is incorporated by reference in its entirety herein.

### TECHNICAL FIELD

This invention relates generally to communications networks and more particularly to packet traffic.

### BACKGROUND

Communications networks of many kinds are known in the art. Many modern networks (such as, for example, a cellular telephony network) are comprised of hundreds or even thousands of network elements that together support thousands or even millions of end-user platforms. It is important to be able to monitor the sub-states of such a network in order to ensure proper operation and to better inform orderly expansion and growth where and as necessary. The sheer size and complexity of such networks, however, comprises a considerable obstacle in these regards.

Many such networks support the conveyance of data packets (for example, most modern cellular telephony networks also serve as mobile data networks). Such data packets are often conveyed pursuant to a given corresponding communication session. As part of monitoring a given network it can be useful or even critical to develop information regarding session context states on a packet-by-packet basis. (Those skilled in the art will understand that the expression “session context” refers to the relevant operational constraints that apply to (or even sometimes define) a given communication situation.) Such networks often support a high-speed line rate and hence the quantity of data traffic supported by a modern network at any given moment is typically huge. When the inherent complexity of a network is combined with this sheer volume of traffic, the task of effectively and efficiently developing information regarding session context states is vexing. These difficulties are further exacerbated by the fact that such processing must typically occur more-or-less in real time. And such a challenge becomes even more imposing when looking to effect such a capability without greatly increasing the required number of packet-processing equipments and/or greatly increasing the native resources of any given packet-processing platform.

High line-rate hardware-based packet-processing platforms (such as, for example, network processors and field programmable gate arrays (FPGA)) have been used to manage session context. This typically comprises inspecting an incoming data stream and forwarding the session signaling messages to a control plane or host general processor of a network processor/FPGA board to permit the session context identification and management. Unfortunately, the control plane is often underpowered to handle the large number of sessions that typify modern network activity. Accordingly, this approach often requires a large number of additional host processors to accommodate such loading requirements. Somewhat similarly, such an approach utilizes the micro engines of the network processor/FPGA and this makes it correspondingly difficult to construct complex data structures to store session context states for every data packet on a per-session basis in a high-bandwidth application setting.

### BRIEF DESCRIPTION OF THE DRAWINGS

The above needs are at least partially met through provision of the method and apparatus pertaining to updating a high-bandwidth hardware-based packet-processing platform local session context state database described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention; and

FIG. 4 comprises a schematic view as configured in accordance with various embodiments of the invention;

FIG. 5 comprises a flow diagram as configured in accordance with various embodiments of the invention.

Skilled artisans will appreciate that components in the figures are illustrated for simplicity and clarity and have not necessarily been drawn to scale. For example, the dimensions and/or relative positioning of some of the components in the figures may be exaggerated relative to other elements to help to improve understanding of various embodiments of the present invention. Also, common but well-understood components that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments comprise or are suitable for implementation by a hardware-based packet-processing platform that is configured to be installed at a traffic-aggregation point for a communications network having a plurality of attachment points at its edge. Still speaking generally, these teachings provide for receiving (via, for example, a packet-receiving interface) at least substantially all data packets as pass through the traffic-aggregation point and then extracting session context state data from at least a majority of these data packets. By one approach, this session context state data comprises, at least in part, information pertaining to a location as pertains to a calling party (such as the point of network attachment for that calling party). This session context state data is then used to update a local session context state database.

By one approach, these teachings provide for so receiving and processing substantially all data packets as pass through the traffic-aggregation point.

These teachings will accommodate various approaches with respect to the aforementioned updating activity. By one approach, for example, this can comprise using a plurality of independent local data bases and using a stream identifier as was retrieved from a given one of the data packets to identify the particular one of the independent local data bases to employ when storing session context state information as pertains to that data packet. For example, this can comprise using at least a portion of that stream identifier as a hash to access a lookup table that correlates such input to the particular local data base.

By employing such teachings, it becomes possible to monitor session context state information on a per-session basis in a real-time manner that does not overburden typically-available enabling platforms such as network processors, FPGA's, and so forth. This, in turn, permits these teachings to be readily fielded in conjunction with existing networks to thereby leverage the productivity and reliability of such networks. Those skilled in the art will further appreciate that these teachings are highly scalable and can be effectively employed in a wide variety of networks and in conjunction with any number of application settings.

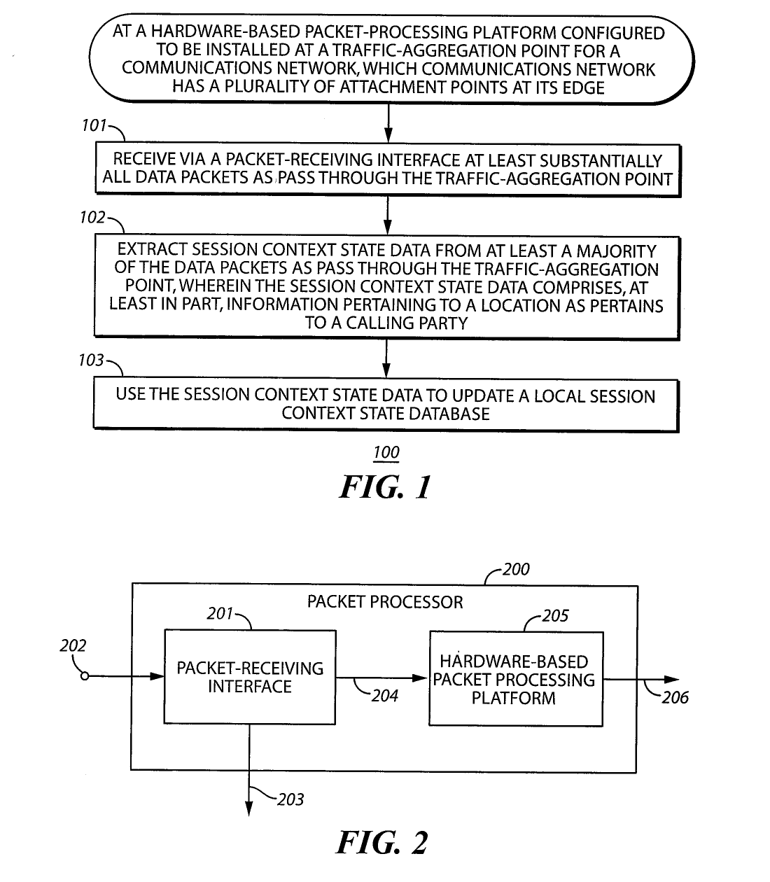

These and other benefits may become clearer upon making a thorough review and study of the following detailed description. Referring now to the drawings, and in particular to FIG. 1, an illustrative process 100 that is compatible with many of these teachings will now be presented.

As alluded to above and as a non-limiting example in these regards, this process 100 can be practiced at a high-bandwidth hardware-based packet-processing platform that is configured to be installed at a traffic-aggregation point for a communication network. Referring momentarily to FIG. 2, such a platform can comprise, for example, a packet processor 200 that comprises a packet-receiving interface 201 that is configured to receive data packets at an input 201. By one approach, this packet-receiving interface 201 can be configured to immediately pass through such data packets at a corresponding output 203 to permit the further processing and/or forwarding of such data packets as appropriate while also passing mirrored data packets via another output 204 to a hardware-based packet processing platform 205.

As used herein, this reference to a “hardware-based” platform shall be understood to refer to a platform that has and utilizes a dedicated-purpose non-programmable apparatus to accomplish at least a majority of its packet-processing functionality as per these teachings This comprises, by way of example and at the least, making use of hardware-based threads, data structures, and messaging queues as pertain to the processing of individual packets. (The reference to “non-programmable” shall itself be understood to refer to a lack of reliance upon software but shall not be understood to refer to only a static, fixed capability.)

This high-bandwidth hardware-based packet-processing platform 205 can itself comprise, in part, a local session context state database. In the alternative, the packet processor 200 can have a local session context state database that is operably coupled to the high-bandwidth hardware-based packet-processing platform 205. In either case, as used herein, this reference to “local” will be understood to refer to a capability that is physically native to the packet processor itself. It will also be understood that this reference to “database” will be understood to refer to an integrated, logically-related collection of records that together form a common pool of information. For example, a “database” would not comprise a mere buffer memory that only temporarily holds whatever data is placed within it pending the removal of that data in furtherance of some related task.

As noted above, such a high-bandwidth hardware-based packet-processing platform is configured to be installed at a traffic-aggregation point for a communications network. As used herein, this reference to a “traffic-aggregation point” shall be understood to refer to a point within the communications network where multiple streams of (inbound and/or outbound) packets are present in a combined, multiplexed form.

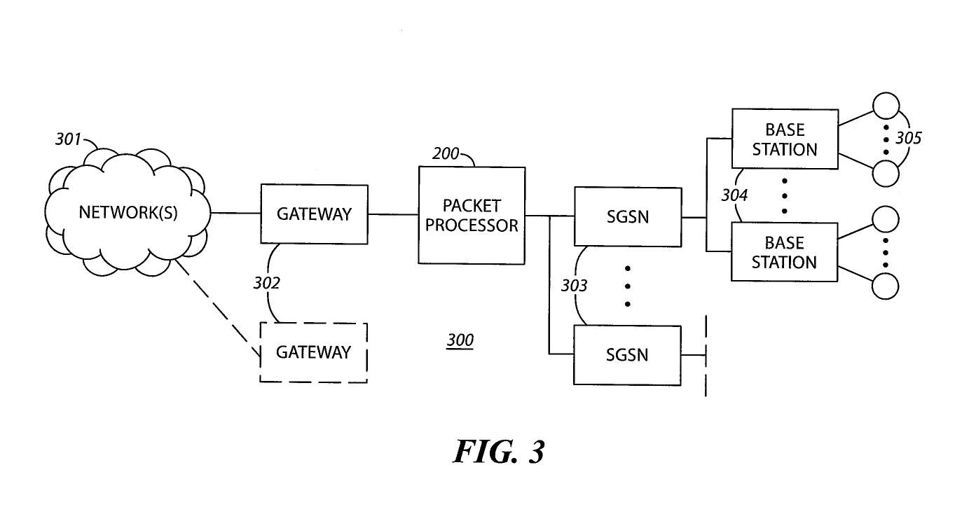

By way of illustration in these regards, and referring now momentarily to FIG. 3, a given communications network 300 (such as a wireless cellular telephony network of choice) can couple to one or more external networks 301 (such as, but not limited to, the Internet) via one or more gateways 302 as are known in the art. Those skilled in the art will recognize that such a gateway 302 is often viewed as an “anchor” point for communication sessions being supported by the network 300.

Such a gateway 302 serves, amongst other things, as a traffic-aggregation point for the network 300. In a typical application setting, such a gateway 302 will often operably couple to a plurality of data packet distributing network elements such as Serving GPRS Support Nodes (SGSN's) 303 (where GPRS is an acronym for General Packet Radio Service). These SGSN's 303, in turn, each typically operably couple to a plurality of corresponding base stations 304 that each typically supports a plurality of attachment points 305 at the edge of the network 300.

Such an architectural approach is well understood in the art and requires no particular further elaboration here, especially as these teachings are not particularly sensitive to numerous variations with respect to the particulars of a given application setting. What will be clear to the reader is that data packets bound for numerous diverse network destinations (and extra-network destinations) via different corresponding data-packet pathways through the network 300 will pass through the gateway 302 (and vice versa, of course). Accordingly, and as noted earlier, this architectural configuration makes the gateway 302 a traffic-aggregation point for the network 300 (notwithstanding that such a network 300 may have numerous such gateways 302 as suggested by the illustration).

Those skilled in the art will recognize that the specifics of this example are intended to serve an illustrative and non-limiting purpose. In particular, this example is intended to illustrate the notion that a traffic-aggregation point comprises a point that is logically proximal to a data-packet pathway interface (here, the gateway 302) between the communications network 300 and an external network 301 (here, for example, the Internet).

So configured, the aforementioned packet processor 200 can be operably located to communicatively couple to the network side of the gateway 302. Referring again to FIG. 1, step 101 then provides for using such a platform 200 to receive via its packet-receiving interface 201 at least substantially all data packets as pass through the traffic-aggregation point. In many application settings it may be useful for the packet-receiving interface 201 to in fact receive all data packets as pass through the traffic-aggregation point.

Step 102 of this process 100 provides for extracting session context state data from at least a majority of these data packets as pass through the traffic-aggregation point. And again, for many application settings, it may be useful for this step to comprise extracting session context state data from all of the data packets as pass through the traffic-aggregation point.

The session context state data itself can vary somewhat from one application setting to another. Generally speaking, this session context state data will at least comprise information pertaining to a location as pertains to a calling party. This location can comprise, for example, the point of attachment between a given end-user platform and the edge of the network (including both an initial point of attachment as well as subsequent points of attachment as the end-user platform moves during the course of a given communication session). This might comprise, for example, a cell site identifier and/or a cell-site sector identifier, which identifiers are known in the art.

Other examples of potentially useful information are (but are not limited to) the telephone number of an originating party, the mobile identifier for a called party, an identifier for a server to which a given party is switching, the type of device that is sourcing or receiving the corresponding data packet, dropped call/session information, the type of radio access network (RAN) (for example, whether the RAN is 2G, 3G, WiFi, WiMax, and so forth), SGSN identifiers (to track, for example, when the call-handling point is handed over from a first SGSN to a second SGSN), an end-user's network quality of service (QoS) class, and so forth.

At step 103 this process 100 then uses this extracted session context state data to update a local session context state database. These teachings will of course also accommodate forwarding such information (either as-is or in some aggregated or otherwise representative form) but this step specifically contemplates updating a local storage resource in these regards.

This step 103 can be realized in any of a variety of ways. By one general example (but without intending any particular limitations in these regards), this step can comprise updating session context state information as is stored in one of a plurality of independent local data bases. By one approach, a stream identifier as is retrieved from a given one of the data packets can be used to identify a particular one of the plurality of independent local data bases. For example, at least a portion of such a stream identifier can be used as a hash to access a lookup table that correlates such input to a particular one of the plurality of independent local data bases. (Stream identifiers are known in the art and comprise a one or more bit expression that identifies, uniquely within the network or some designated portion thereof, a particular data session.)

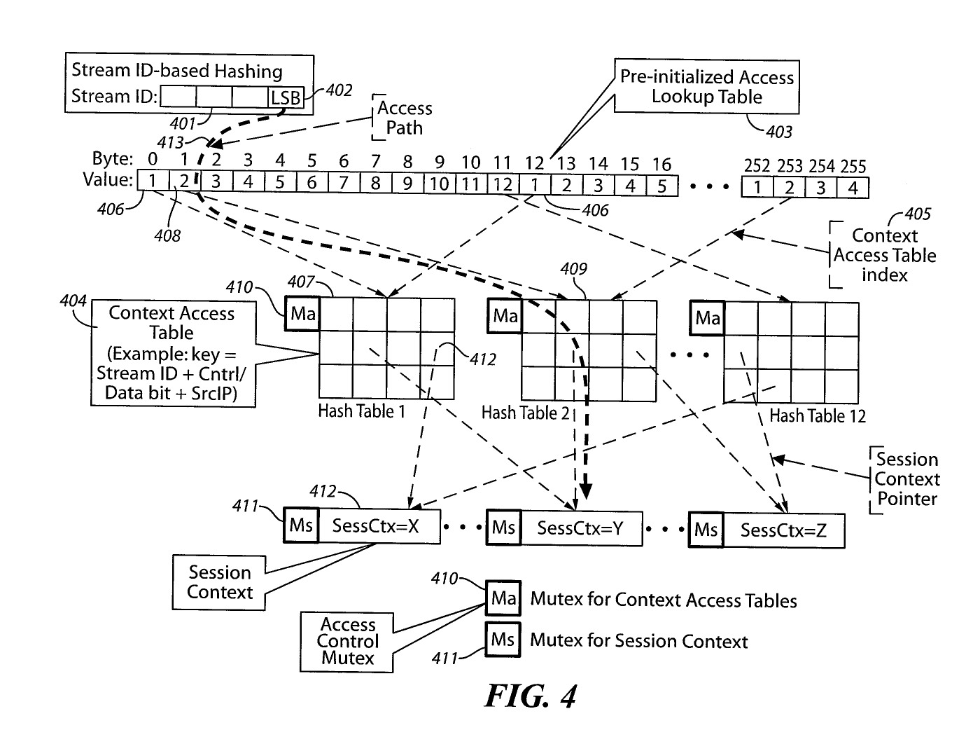

A more specific illustration in these regards may be helpful to some readers. Those skilled in the art will understand, however, that the specifics of the following example not presented as an exhaustive characterization in these regards. With these cautions in mind, and referring now to FIG. 4, a particular illustrative approach in these regards will be presented.

As noted earlier, a stream identifier (ID) 401 can be retrieved from a given data packet. A portion (or portions, or all) of this stream identifier 401 is then parsed for use as a hash value. In this illustrative example, the least significant byte (LSB) 402 of the stream identifier 401 serves this purpose. In this example, it will be presumed that this LSB 402 can have a value ranging from zero to 255.

This hash value 402 is employed to access a fixed-size pre-initialized access look-up table 403. This look-up table 403 correlates the various potential values for the LSB 402 with, in this example, one of twelve content access tables 404 (also referred to in the illustration as hash tables). More particularly, this comprises associating each possible hash value with a corresponding content access table index 405.

For example, a hash value of zero is correlated in the look-up table 403 to a context access table index value of one 406. The latter, in turn, points to a first context access table 407. As the hash value of 12 also has this same context access table index value (i.e., “1”) 406 this hash value also points to the first context access table 407. Similarly, a hash value of one correlates in the look-up table 403 to a context access table index value of two 408. The latter, in turn, points to a second context access table 409. In this illustrative example there are twelve context access tables 404.

Those skilled in the art will recognize that this plurality of tables 404 can also be fewer, or greater, in number as desired. It should be understood that the number of such tables 404 need not correlate in any particular manner (for example, by matching) the number of anticipated or supported hardware threads. The described approach, of course, avoids the use of one large session context table that encompasses all monitored session contexts. As a result, the monitored session contexts tend to be fairly evenly spread out over the various tables 404. This, in turn, tends to mitigate or even eliminate the locking or jamming of independent processor threads as these session context lookups similarly tend to be relatively evenly spread out over the available tables 404.

These teachings will accommodate the use of an access control mutex component 410 (denoted in representative form as “Ma” in FIG. 4) (where “mutex” will be understood to comprise an abbreviation of “mutual exclusion” as is known in the art). This mutex component Ma 410 serves to prevent concurrent access of the corresponding context access table 404 by multiple independent processor threads. These teachings will similarly accommodate using a session context mutex component 411 (denoted in representative form as “Ms” in FIG. 4). This mutex component 411 serves to prevent concurrent access to a given session context entry. The form and use of mutex components comprises a generally well-understood area of endeavor. Accordingly, for the sake of brevity, further elaboration here in these regards will be avoided.

Each context access table 404 comprises a plurality of session context components 412. These components 412 contain the session context information that are used for processing the aforementioned incoming data packets.

Using the described approach a more specific illustrative example will now be offered. Those skilled in the art will recognize and understand that this example is intended to serve only in an illustrative capacity and is not intended to comprise an exhaustive listing of all possibilities in this regard.

As already mentioned, this approach uses a least-significant byte 402 of an incoming stream identifier 401 to hash into the pre-initialized access lookup table 403. In this example, this least-significant byte 402 has the value “1.” Following the access path denoted by reference numeral 413, this results in identifying a context access table index value of “2.” Following the access path 413, this index value of “2” leads to the second context access table 409. A look-up key can then serve to hash into this particular context access table 409 to locate the appropriate session context information.

There are various ways by which this look-up key can be derived. As but one illustrative example in these regards, such a look-up key can be formed by combining part or all of the aforementioned stream identifier 401 with a signaling/data bit flag and a source Internet Protocol address as was also obtained from the data packet content.

Once the correct session context component 412 has been identified, the supported process(es) can then use that information as desired. This can comprise, for example, updating that information or retrieving that information and forwarding part or all of the retrieved content to another location for subsequent processing, evaluation, or the like.

Those skilled in the art will appreciate that the mutual exclusiveness inherent to such an approach will serve to protect multiple hardware threads from concurrent accessing the same context access table and session context. There are other corresponding benefits worth noting as well. As one example, such teachings contribute significantly to the efficiency of the storage organization. In particular, this highly specific and hieratical way of accessing the session context well accommodates efficient ways of segmenting a limited amount of available memory. As another example, such teachings also contribute significantly to the efficiency of corresponding read-only access and write-only lock functionality. In particular, given a usual need to process high-bandwidth links in real-time, the described organization allows fast lookup while making a good compromise with respect to concurrent accesses. With multi-level write-only mutexes, some hardware threads will spend their times on reading without locking, some threads will likely just spend their time locking the context access table, and yet others will likely spend their time on locking the session contexts, thus spreading out the reading and locking activities over smaller data structures to thereby promote more concurrency.

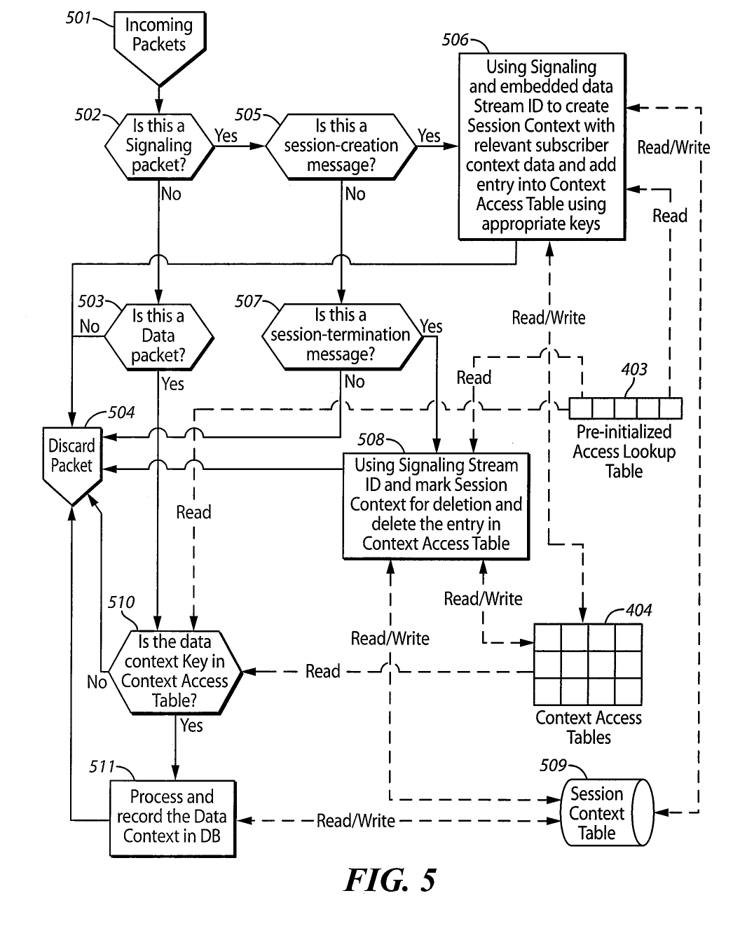

Referring now to FIG. 5, some additional details regarding certain ways in which these teachings can be applied will be described. As with other examples provided herein, the specifics of this additional description are intended to serve in an illustrative and non-limiting manner.

Upon receiving an incoming packet at step 501, the aforementioned processor determines, at step 502, whether the packet comprises a signaling packet. When untrue, the processor determines at step 503 whether the packet comprises a data packet. If this, too, yields an untrue result, the processor simply discards the packet at step 504.

When the packet does comprise a signaling packet, the processor then determines if this signaling packet comprises a session-creation message at step 505. When true, the processor, at step 506 retrieves the signaling stream identifier and the allocated data stream identifier from the packet and uses the signaling stream identifier (as described above, for example) to create a session content populated with relevant session data from the packet itself. The processor then uses an appropriate key (taken from or formed using data from the packet) to insert the corresponding session context pointer into the context access tables 404. In this case, this can occur for both entries generated from the signaling stream identifier and the data stream identifier-based keys. The packet itself can then be discarded at step 504.

When the signaling packet does not comprise a session-creation message, the processor determines at step 507 whether this signaling packet comprises a session-termination message. When false, the processor simply discards the packet at step 504. When true, however, the processor, at step 508, retrieves the signaling stream identifier from the packet. The processor uses this identifier to mark the hashed session context as stored in a session context table 509 for deletion and also deletes the entry in the hashed context access table 404.

If desired, such a process will also accommodate similarly determining whether a given signaling packet comprises a session-updating message. In such a case, when the signaling packet does not comprise a session-creation message, the processor can further determines whether this signaling packet comprises a session-updating message. When false, the processor can again simply discard the packet at step 504. When true, however, the processor can retrieve the signaling stream identifier from the packet and use this identifier to update the database 509 accordingly.

When the signaling packet is neither a session-creation message nor a session-termination message, at step 510 the processor determines whether a data context key as retrieved from the packet is present in the context access table 404. When false, the processor discards the packet at step 504. When true, however, at step 511 the processor uses the key retrieved at step 510 to hash into the context access table 404 and identify the correlated session context pointer (as described above) that points to the corresponding session context as pertains to this packet. Using this information the processor can then process and record the data context in the database 509. With this task completed the processor then discards the packet at step 504.

Those skilled in the art will appreciate that these teachings are readily applied in conjunction with numerous existing network architectures and configurations. It will further be appreciated that these teachings are readily scaled and will accommodate a wide variety of bandwidth capacities. The skilled artisan will also recognize that these teachings can be applied in a way that greatly leverages existing hardware-based platforms, such as existing network processors and/or FPGA's, such that these platforms are able to effectively effect the desired processing and updating activity in a real-time manner that maintains pace with the rate at which the packets are passing through the monitored traffic-aggregation point. In particular, those skilled in the art will appreciate that these teachings allow the described functionality to be done directly on a small hardware-based packet-processing card that resides in a small server in direct opposition to traditional thinking and practices in these regards. It will also be appreciated that the efficient organization of the database and such look-up methods minimize corresponding memory requirements and also allow fast indexing that can be readily implemented on platforms such as typical network processors or FPGA's.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a high-bandwidth hardware-based packet-processing platform configured to be installed at a traffic-aggregation point for a communications network, which communications network has a plurality of attachment points at its edge:
receiving via a packet-receiving interface at least substantially all data packets as pass through the traffic-aggregation point;
extracting session context state data from at least a majority of the data packets as pass through the traffic-aggregation point, wherein the session context state data comprises, at least in part, information pertaining to a location as pertains to a calling party;
using the session context state data to update a local session context state database.

2. The method of claim 1 wherein receiving via a packet-receiving interface at least substantially all data packets as pass through the traffic-aggregation point comprises receiving mirrored data packets.

3. The method of claim 1 wherein the communications network comprises a wireless cellular telephony network.

4. The method of claim 1 wherein receiving via a packet-receiving interface at least substantially all data packets as pass through the traffic-aggregation point comprises receiving all data packets as pass through the traffic-aggregation point.

5. The method of claim 4 wherein extracting session context state data from at least a majority of the data packets as pass through the traffic-aggregation point comprises extracting session context state data from all of the data packets as pass through the traffic-aggregation point.

6. The method of claim 1 wherein using the session context state data to update a local session context state data base comprises updating session context state information as is stored in one of a plurality of independent local data bases.

7. The method of claim 6 wherein using the session context state data to update a local session context state data base further comprises using a stream identifier as retrieved from a given one of the data packets to identify a particular one of the plurality of independent local data bases.

8. The method of claim 7 wherein using the stream identifier to identify a particular one of the plurality of independent local data bases comprises using at least a portion of the stream identifier as a hash to access a lookup table that correlates such input to a particular one of the plurality of independent local data bases.

9. An apparatus configured to be installed at a traffic-aggregation point for a communications network, which communications network has a plurality of attachment points at its edge, the apparatus comprising:
a packet-receiving interface configured to receive at least substantially all data packets as pass through the traffic-aggregation point;
a high-bandwidth hardware-based packet-processing platform configured to:
extract session context state data from at least a majority of the data packets as pass through the traffic-aggregation point, wherein the session context state data comprises, at least in part, information pertaining to a location as pertains to a calling party;
use the session context state data to update a local session context state database.

10. The apparatus of claim 9 wherein the traffic-aggregation point is logically proximal to an interface between the communications network and the Internet.

11. The apparatus of claim 9 wherein the communications network comprises a wireless cellular telephony network.

12. The apparatus of claim 9 wherein the high-bandwidth hardware-based packet-processing platform is configured to use the session context state data to update a local session context state data base by updating session context state information as is stored in one of a plurality of independent local data bases.

13. The apparatus of claim 12 wherein the high-bandwidth hardware-based packet-processing platform is configured to use the session context state data to update a local session context state data base by using a stream identifier as retrieved from a given one of the data packets to identify a particular one of the plurality of independent local data bases.

14. The apparatus of claim 13 wherein the high-bandwidth hardware-based packet-processing platform is configured to use the stream identifier to identify a particular one of the plurality of independent local data bases by using at least a portion of the stream identifier as a hash to access a lookup table that correlates such input to a particular one of the plurality of independent local data bases.
